(19) United States
(12) Patent Application Publication
(10) Pub. No.: US 2021/0364085 A1
(43) Pub. Date: Nov. 25, 2021

(54) TRANSMISSION ASSEMBLY FOR A HYDROSTATICALLY OR ELECTRICALLY PROPELLED VEHICLE

(71) Applicant: CARRARO S.P.A., CAMPODARSEGO (PD) (IT)

(72) Inventors: Stefano FILIPPIN, Santa Maria di Sala, Venezia (IT); Stefano FACCHIN, Vigonza, Padova (IT); Alberto RAMPAZZO, Spinea, Venezia (IT)

(73) Assignee: CARRARO S.P.A., CAMPODARSEGO (PD) (IT)

(21) Appl. No.: 16/969,784

(22) PCT Filed: Jan. 21, 2019
(86) PCT No.: PCT/IB2019/050476

§ 371 Date: Aug. 13, 2020

(30) Foreign Application Priority Data
Jan. 19, 2018 (IT) 102018000001508

(51) Int. Cl. F16H 61/30; F16H 61/00; F16H 61/02; F16H 63/30

(52) U.S. Cl. CPC F16H 61/30; F16H 61/0025; F16H 2061/307; F16H 61/0267; F16H 63/3023; F16H 61/0276

(57) ABSTRACT

A transmission assembly for a hydrostatically or electrically propelled vehicle, comprising an input shaft, an output shaft, a first pair of gears and a second pair of gears, a synchroniser, a hydraulically operated actuator of the synchroniser which comprises a rod, and a hydraulic circuit for moving the rod, wherein the rod comprises an enlarged portion that is slidingly and sealingly housed in a respective portion of the seat so as to define two intermediate chambers. The actuator further comprises a contact element that is slidingly and sealingly housed in a relevant seat that is adjacent to the portion of the sliding seat so as to define a first end chamber, the contact element being able to move independently of the rod and defining an end point of the rod. A second end chamber is defined in an end of the rod that is opposite the enlarged portion.

The present invention relates to a transmission assembly for a hydrostatically or electrically propelled vehicle, in particular an agricultural or industrial vehicle, of the kind comprising a synchroniser that is actuated by means of a rod controlled by a hydraulic circuit.

Drive systems for agricultural and industrial vehicles are generally known which are formed of a hydrostatic motor combined with a variable gear ratio mechanical transmission.

In drive systems of this kind, the mechanical transmission, typically a gear box, makes it possible to broaden the range of speeds at which the vehicle can move forward, thus making said vehicle more suitable for road use. However, it must be understood that the use of mechanical transmissions in systems of this kind presents a series of problems which are primarily linked to the power produced by motors used in applications of this kind.

One solution that is particularly suitable for the required applications uses mechanical transmissions which have two-gear groups that can be selectively engaged by means of a mechanical synchroniser.

Examples of solutions of this kind are disclosed in U.S. Pat. No. 5,505,113 and in European patent EP 2705281.

In solutions of this kind, the synchroniser is actuated by means of a double-acting hydraulic cylinder, which makes it possible to move a movable crown of the synchroniser in two opposing directions until it engages with one toothed wheel or the other, thereby selecting the desired gear.

In order to actuate the hydraulic cylinder, suitable hydraulic circuits are used which are produced in particular so as to optimise the change phase, in order to allow a sufficiently soft transition from one gear to the other. However, a feature of this kind requires the use of relatively complicated circuits and a dedicated controller.

Another reason for the complexity of the hydraulic circuits provided to actuate the synchroniser is linked to the difficulties associated with bringing the synchroniser into a neutral position, thereby putting the transmission into neutral.

As a result, there is a need to provide a transmission assembly which can be actuated by means of simpler hydraulic circuits and in which the synchroniser can be easily brought into a neutral position.

The technical problem addressed by the present invention is therefore that of providing a drive assembly for vehicles that allows at least one of the disadvantages and deficiencies mentioned above with reference to the prior art to be overcome.

This problem is solved by the transmission assembly according to claim 1.

It is noted that the synchroniser of the transmission assembly according to the present invention is actuated by means of an actuator which comprises a rod that has an enlarged portion which is slidably and sealingly housed in a relevant seat, and a contact element which is also slidably and sealingly housed in a relevant seat and can be moved independently of the rod, at least in a direction of mutual separation in the axial direction X.

However, in certain operating conditions the contact element allows an end point to be defined for the rod.

In other words, when the contact element is in a certain position, the stroke of the rod is limited to an intermediate axial position in which the synchroniser is in neutral. In another position, however, the stroke of the rod can proceed further, allowing the corresponding gear to be engaged.

It is also noted that the design described above allows four distinct chambers to be defined, specifically two chambers at the respective ends and two intermediate chambers, these latter chambers being separated by the enlarged portion, into which chambers a flow of operating fluid, typically oil, is delivered in order to accordingly control the rod and the contact element.

As a result, it is possible to obtain the three desired positions, specifically the two gears and the neutral position, using a single flow of fluid.

The fluid can advantageously be delivered by means of two ON/OFF valves which selectively deliver the fluid to the chambers or drain said chambers.

According to one aspect of the invention, for this purpose the transmission assembly comprises a first two-position valve designed to connect so as to connect to drain the first intermediate chamber and the second end chamber and to deliver the operating fluid to the second intermediate chamber in a first operating position, or, vice versa, to deliver the operating fluid to the first intermediate chamber and to the second end chamber and to connect so as to connect to drain the second intermediate chamber in a second operating position.

However, a second two-position valve is preferably designed to connect so as to connect to drain the first end chamber in a first position and to deliver the operating fluid to the first end chamber in a second position.

In some embodiments, valves of this kind can be digital ON/OFF valves.

According to a further aspect of the invention, the fluid acts on respective surface areas defined in the enlarged portion, in the rod and in the contact element.

The surface areas on which the fluid acts can be defined by respective faces of the rod, of the enlarged portion and of the contact element.

The different positions of the rod can preferably be obtained by the contact element having a greater surface area than the surface area of the enlarged portion.

This feature also contributes to simplifying the hydraulic circuit since it is possible to obtain the movements required of the rod by means of the different ON/OFF switching combinations of the two valves.

The enlarged portion preferably also comprises an extension which extends axially in the opposite direction to the rod, which allows the enlarged portion to be kept at a distance from the contact element.

According to a further aspect of the invention, the transmission assembly also comprises a detecting device which detects the axial position of the rod in order to allow the change phases to be controlled, by means of a suitable controller, depending on the position of the rod.

Other advantages, features and the procedures for using the present invention will become clearer from the following detailed description of a few embodiments, shown by way of non-restrictive example. Reference is made to the figures in the accompanying drawings, in which:

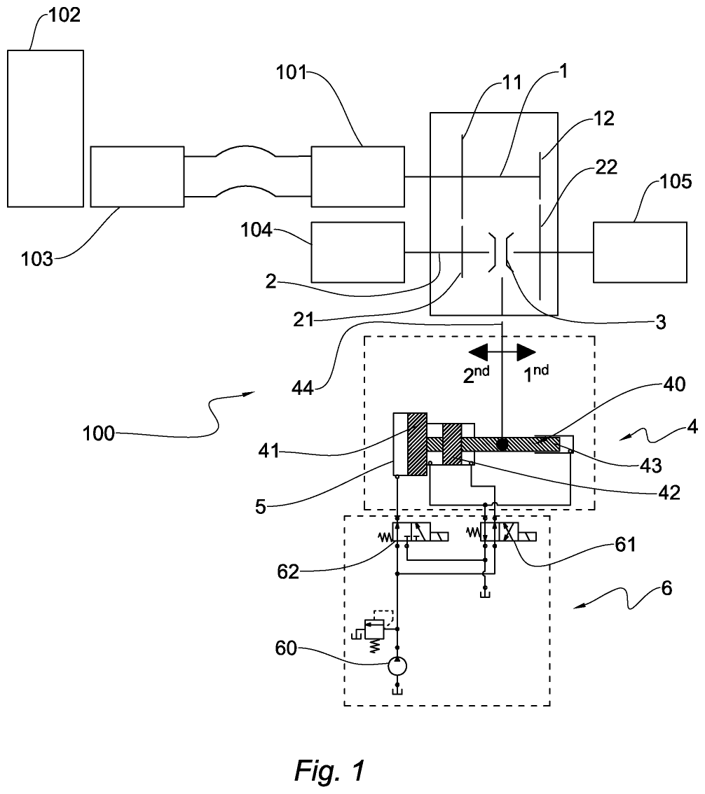

FIG. 1 is a schematic view of a propulsion system comprising a transmission assembly according to the present invention;

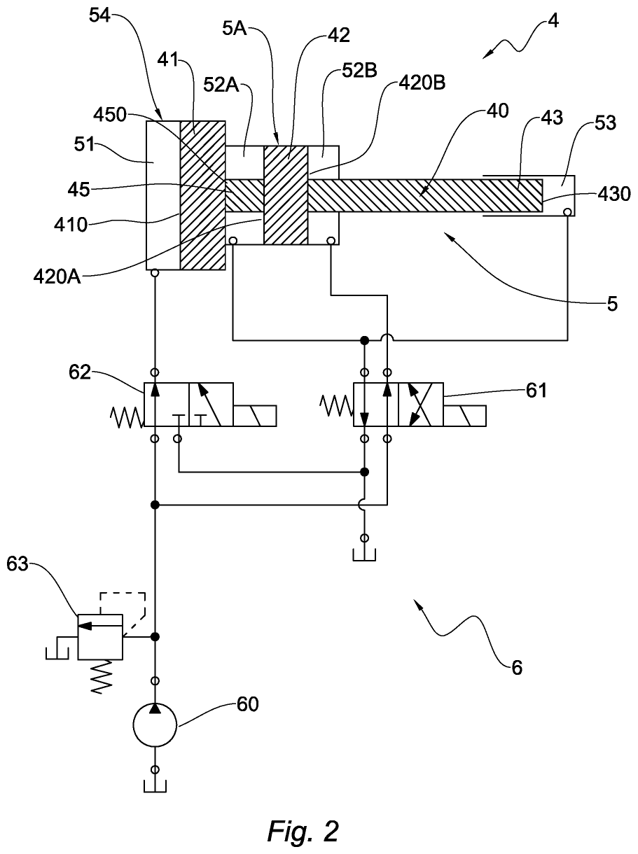

FIG. 2 is a schematic view of an actuator of a synchroniser and of the relevant hydraulic circuit of the transmission assembly according to the present invention;

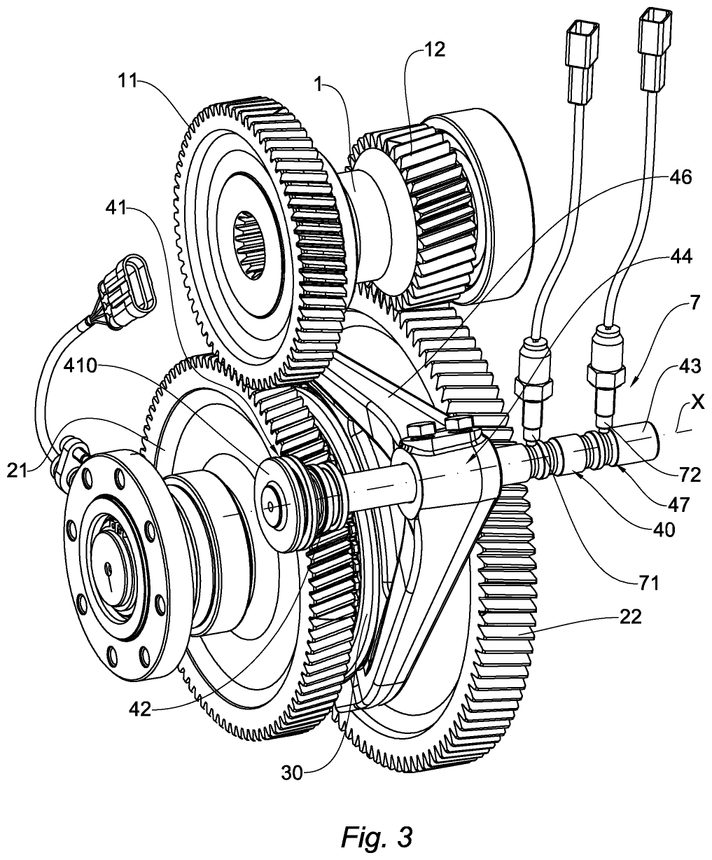

FIG. 3 is a perspective view of the transmission assembly according to the present invention, from which some components have been removed for the sake of clarity; and

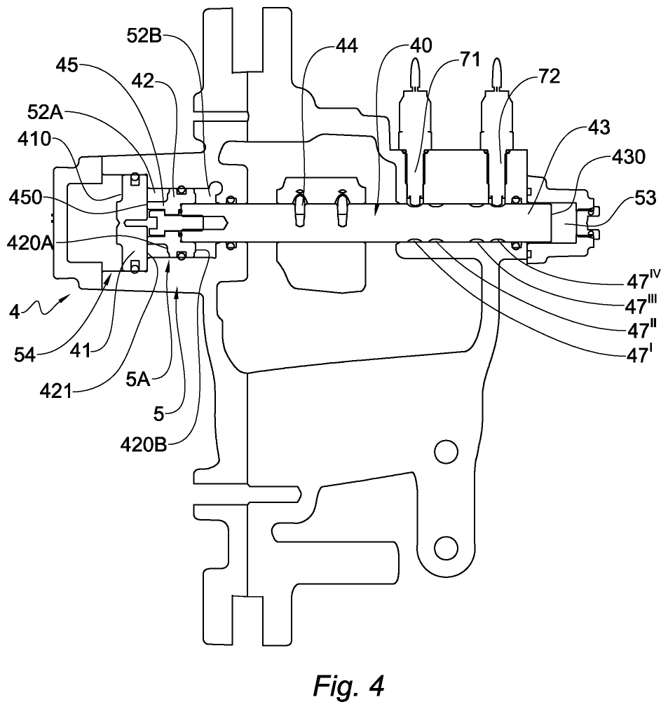

FIG. 4 is a sectional view of the transmission assembly according to the present invention.

With initial reference to FIG. 1, a transmission assembly for a hydrostatically or electrically propelled vehicle is denoted as a whole by the reference numeral 100.

The transmission assembly 100 is intended for use in combination with a hydrostatic motor, as in the example in FIG. 1, or alternatively with an electric motor.

In the embodiment shown, the hydrostatic motor 101 is associated with a pump 103 that is actuated by an internal combustion engine 102.

The transmission assembly 100 is designed so as to transmit the motion of the motor 101 to the wheels of the vehicle, thereby actuating the front axle 104 and/or the rear axle 105.

For this purpose, the transmission assembly comprises an input shaft 1 which can be connected to the motor 101, and an output shaft 2.

In order to allow at least two different gear ratios between the input shaft 1 and the output shaft 2 to be selected, the transmission assembly 100 comprises a first pair of gears 11, 21 and a second pair of gears 12, 22.

As shown in FIG. 3, the gears are dimensioned such that, depending on the pair of gears selected, the motion is transmitted from the input shaft 1 to the output shaft 2 at a different gear ratio.

Again with reference to FIG. 1, the transmission assembly 100 also comprises a synchroniser 3 for selectively engaging the first pair of gears 11, 21 or the second pair of gears 12, 22.

In preferred embodiments, the synchroniser 3 is arranged on the output shaft 2, preferably in an intermediate position between the gears 21 and 22.

According to a preferred embodiment, a movable element 30 of the synchroniser, shown by way of example in FIG. 3, is arranged between the two gears 21 and 22 and is designed so as to move axially along the output shaft 2 so as to make said output shaft rotationally integral with one or the other of the two gears 21 and 22. The meshing system of the synchroniser 3 can be produced in a manner known per se and is not shown in greater detail in the following for this reason.

The assembly 100 also comprises an actuator 4 that is intended to actuate the synchroniser 3 so as to move the movable element 30 in order to select one of the two gears as described above.

The actuator preferably comprises a rod 40 which is connected to the synchroniser 3 by means of a support 44.

In one embodiment, the support 44 comprises an arm 46, preferably a forked arm, which is connected to the movable element 30, as shown in the embodiment in FIG. 3.

The assembly 100 is also associated with a hydraulic circuit 6 that allows the rod 40 to be moved in an axial sliding direction X in ways which will be described in the greater detail in the following.

The actuator 4 is in fact actuated hydraulically by means of the aforementioned circuit 6, which controls the movement of the rod 40 inside a relevant sliding seat 5.

Now also with reference to FIG. 2, the rod 40 comprises an enlarged portion 42 that is slidably and sealingly housed in a respective portion 5A formed in the sliding seat 5.

In other words, a cylinder-piston coupling is produced between the enlarged portion and the portion of the sliding seat. For this purpose, in some embodiments the enlarged portion comprises a sealing element, shown schematically in FIG. 4A, which acts on lateral walls of the relevant seat portion.

The enlarged portion 42 defines two chambers 52A, 52B in the portion 5A, which chambers will also be referred to in the following as intermediate chambers. A flow of oil, or other operating fluid, can be introduced inside each of the intermediate chambers 52A, 52B. Once the fluid has been introduced into one or the other chamber, the enlarged portion 42, and therefore also the rod 40 with which it is integral, is subjected to translation in one orientation or the other along the sliding direction X.

In fact, introducing the oil into one of the two chambers 52A, 52B produces a thrust effect on the enlarged portion 42 in one or the other axial translation direction of the rod.

For this purpose, as can be seen in FIG. 4A, the chambers 52A, 52B are defined, as well as by the walls of the seat 5, by respective opposing faces 420A, 420B of the enlarged portion 42.

The enlarged portion 42 preferably also comprises an extension 45 which extends axially in the opposite direction to the rod 40.

In one embodiment, the extension 45 defines a further face 450 which, for example, can have the same cross section as the rod.

The opposing faces 420A, 420B are therefore defined by an annular surface area about the extension 45 and the rod 40, respectively.

The actuator 4 further comprises a contact element 41 that is also slidably and sealingly housed in a relevant seat 54 that is adjacent to the portion 5A of the sliding seat 5 so as to define a first end chamber 51, inside which a flow of oil can also be introduced.

According to a preferred embodiment, the contact element 41 forms, on one face thereof, a wall 421 of the chamber 52A, opposite the face 420A of the enlarged portion 42.

As can be seen from FIG. 3, the contact element 41 can for example be disc-shaped coaxially with the direction X, and can be provided with a slot for housing a sealing element, shown schematically in FIG. 4A.

According to one aspect of the invention, the contact element 41 can be moved in the same axial sliding direction X as the rod 40 independently of said rod, at least in a direction of mutual separation.

According to a preferred embodiment, the first end chamber 51 is defined, as well as by the walls of the seat 5, by a face 410 of the contact element 41, which delimits the extension thereof. It is therefore noted that, once the oil has been introduced into the chamber 51, a thrust effect is produced on the contact element 41 that is proportional to the surface area of the face 410 on which the pressure of the oil acts. It is noted that, within the context of the present invention, the surface area of a face is intended to mean the projection of said face on a plane perpendicular to the axis X, that is to say the projection that the thrust from the oil in said direction determines.

It is therefore clear that this design makes it possible to ensure that the rod 40, in its axial translation, enters into contact with the contact element 41 when said element is in the closest position to the chamber 52A. However, when the end chamber 51 is pressurised, the axial translation of the contact element 41 is prevented, unless the force which acts on the face 410 of the latter is overcome.

As can be seen from the figures, and as described in greater detail in the following, the contact element 41 is larger than the enlarged portion 42 and, in these circumstances, when the pressure in the relevant chamber is equal, the thrust that acts on the contact element is greater than that which acts on the enlarged portion 42.

In this way, when the chamber 51 is pressurised, the contact element 41 defines an end point of the rod 40. Vice versa, if the chamber 51 is drained, the rod 40 can also translate in an axial direction towards the chamber 51.

The actuator 4 also comprises a second end chamber 53 which is defined in the end 43 of the rod 4 that is axially opposite the end enlarged portion 41.

Similarly to what is shown for chambers 51 and 52A, B, the second end chamber is defined, as well as by the walls of the seat 5, by an end face 430 of the rod 40. According to a preferred embodiment, the end face 430 is therefore dimensioned such that the total surface area formed by the faces 420A and 450 that face the first intermediate chamber 52A is equal to the total surface area formed by the faces 420B and 430.

Introducing the oil into the chamber 53 creates a thrust effect on the rod 40 that is proportional to the surface area of the face 430 on which the oil introduced into the chamber 53 acts. In this case, the thrust stresses the rod in a direction opposite to the direction produced after filling the chamber 51.

This action is useful in particular in the transition phases between either position of the rod 40.

According to a preferred embodiment, the face 410 of the end enlarged portion 41 has a greater surface area than the surface area of each of the opposing faces 420A, 420B of the intermediate enlarged portion 42.

Therefore, as indicated above, by introducing a flow of oil at the same pressure, the contact element 41 produces a thrust effect that is greater than that which can be exerted individually by each of the faces 420A, B and 430 and than the sum thereof.

Therefore, when the chamber 51 is pressurised, the action of the rod 40 is not able to push the contact element 41, thereby limiting the stroke of the rod. However, when draining the chamber 51, the action on the intermediate chamber 52B is enough to move the contact element 41, thereby allowing an additional stroke for the rod.

This means that, by variously combining filling or draining the chambers 51, 52A, B and 53, it is possible to engage one of the two gears or to bring the system into neutral, i.e. so as to have the rod 40 in a neutral position, irrespective of the starting position thereof.

In fact, by delivering oil to the chambers 51 and 52B and by draining the other chambers, the rod 40 is brought into a neutral position, as shown in FIG. 4, thereby allowing the synchroniser to be kept in neutral.

By delivering a flow of oil to the first end chamber 51 and to the chambers 52A and 53, the rod 40 is stressed in a direction opposite to the chamber 51, thereby selecting a first gear of the synchroniser.

However, by delivering a flow of oil to the chamber 52B and draining the other chambers, the rod 40 is stressed towards the chamber 51, thereby selecting the second gear of the synchroniser.

Due to the ratio between the dimensions of the faces described above, this design makes it possible to obtain a similar thrust action on the rod, and therefore on the synchroniser, both when changing from neutral to first gear and when changing from neutral to second gear, thereby guaranteeing correct functioning of the synchroniser.

The aforementioned combination of positions can advantageously be produced by using two two-way ON/OFF valves 61, 62 which receive a common flow of oil by means of a feed pump 60, preferably paired to a pressure regulator 63, as shown in the diagram in FIG. 2.

In one embodiment, a first valve 61 is connected by means of one line to the chambers 52A and 53 and by means of the other line to the chamber 52B.

The first valve 61 is therefore preferably designed to deliver the operating fluid to the first intermediate chamber 52A and to the second end chamber 53 and to connect so as to connect to drain the second intermediate chamber 52B in a first operating position, or, vice versa, to connect so as to connect to drain the first intermediate chamber 52A and the second end chamber 53 and to deliver the operating fluid to the second intermediate chamber 52B in a second operating position.

However, a second valve 62 is connected solely to the end chamber 51.

The second valve 62 is preferably designed to connect so as to connect to drain the first end chamber 51 in a first position or to deliver the operating fluid to the first end chamber 51 in a second position.

In a preferred embodiment, the valves are normally de-energised, i.e. in the OFF position. In other words, the valves 61 and 62 are normally in the second position described above.

However, switching the two valves 61 and 62 into the various possible combinations makes it possible to obtain the two gears and the neutral position as described above.

The following table summarises the switching of the valves into the different positions of the synchroniser 3.

TABLE 1

| | Valve 61 | Valve 62 |
|---|---|---|
| Neutral position | OFF | OFF |
| First gear | ON | OFF |
| Second gear | OFF | ON |

According to a preferred embodiment, the drive assembly also comprises a detecting device 7 which is designed to detect the axial position of the rod 40. In one embodiment, the detecting device 7 comprises a pair of sensor elements 71, 72 which detect the position of respective identification elements 47 associated with the rod. The identification elements 47 are preferably arranged on the opposite side of the enlarged portion 42 with respect to the support 44.

In one embodiment, the sensor elements 71, 72 are position switches which act on respective slots formed on the rod.

For example, four slots 47^{I}, 47^{II}, 47^{III}, 47^{IV} can be provided. When the rod 40 is in the neutral position, the two position switches are in the two end slots 47^{I}, 47^{IV}.

However, when the rod 40 is moved into one of the gears, one switch is in a corresponding central slot 47^{II}, 47^{III} while the other switch is outside the slots and therefore switched into the second operating position thereof. In fact, the position switches are provided with a movable contact portion, which is pushed and pulled back into the body of the switch after contacting the surface of the rod 40.

It is nevertheless clear that different solutions can be provided for the detecting device 7 which can, for example, be based on an optical reader.

Moreover, the same operating principle described above in relation to the solution of two switches and four slots can also be applied to solutions which use other types of sensor elements and corresponding identification elements.

It is therefore clear that the described drive assembly allows the problems identified to be solved with reference to the present invention, due to the use of the synchroniser actuated by the actuator that is provided with a rod and contact element.

It is also noted that the transmission assembly according to the present invention is advantageously suitable for being controlled according to the method defined in patent EP 2705281, which was cited above.

For this purpose, the motor 100 can be a variable cylinder engine and the valves can be associated with a control unit that is not shown in the drawings.

The control unit can also advantageously be interfaced with speed sensors of the input and output shafts, so as to also be able to control the movement of the arm of the synchroniser depending on the difference in speed between the two shafts.

In this way, the same advantages in terms of speed and precision of changing that are offered by the teachings of patent EP 2705281 can also be guaranteed in the transmission assembly according to the present invention.

1. Transmission assembly (100) for a hydrostatically or electrically propelled vehicle, comprising:
a. an input shaft (1), connectable to a motor (101) of the vehicle,
b. an output shaft (2),
c. a first pair of gears (11, 21) and a second pair of gears (12, 22) for transmitting the motion from the input shaft (1) to the output shaft (2) at different gear ratios,
d. a synchronizer (3) for selectively engaging the first pair of gears (11, 21) or the second pair of gears (12, 22),
e. a hydraulically operated actuator (4) of the synchronizer (3), which comprises a rod (40) that axially movable inside a relevant sliding seat (5) in an axial sliding direction (X), and
f. a hydraulic circuit (6) for moving said rod (40),
wherein said rod (40) comprises an enlarged portion (42) that is slidably and sealingly housed in a respective portion (5A) of said sliding seat (5) so as to define two intermediate chambers (52A, 52B), said actuator (4) further comprising a contact element (41) that is slidably and sealingly housed in a relevant seat (54) that is adjacent to the portion (5A) of said sliding seat (5) so as to define a first end chamber (51), said contact element (41) being able to move in said axial sliding direction (X) independently of said rod (40) and defining an end point for the movement of said rod (40) in said axial sliding direction (X), a second end chamber (53) being defined in an end (43) of the rod (40) that is opposite the enlarged portion (42), said hydraulic circuit (6) being designed to deliver, in a controlled manner, a flow of operating fluid to each of said first end chamber (51), intermediate chambers (52A, 52B) and second end chamber (53), and in that one side of said first end chamber (51) is defined by a face (410) of the contact element (41), respective sides of said intermediate chambers (52A, 52B) are defined by a relevant side of opposing faces (420A, 420B) of the enlarged portion (42), and a side of said second end chamber (53) is defined by an end face (430) of said rod (40), said enlarged portion (42) comprising an extension (45) which extends axially in the opposite direction to the rod (40), wherein said extension (45) defines an additional face (450), the total extension of the surface area formed by the face (420A) of the enlarged portion (42) that faces the first intermediate chamber (52A) and by said additional face (450) being equal to the total extension of the area formed by the face (420B) of the enlarged portion (42) that faces the second intermediate chamber (52B) and by said face (430) of the opposing end (43).

2. The transmission assembly (100) according to claim 1, wherein said hydraulic circuit comprises a first two-position valve (61) configured to connect so as to connect to drain the first intermediate chamber (52A) and the second end chamber (53) and to deliver the operating fluid to the second intermediate chamber (52B) in a first operating position, or, vice versa, to provide the operating fluid to the first intermediate chamber (52A) and to the second end chamber (53) and to connect so as to connect to drain the second intermediate chamber (52B) in a second operating position, and a second two-position valve (62) designed to connect so as to connect to drain said first end chamber (51) in a first position of the second two-position valve (62) or to provide the operating fluid to the first end chamber (51) in a second position of the second two-position valve (62).

3. The transmission assembly (100) according to claim 1, wherein said face (410) of the contact element (41) has a greater surface area than the surface area of each of the opposing faces (420A, 420B) of the enlarged portion (42).

4. The transmission assembly (100) according to claim 1, wherein said actuator (4) is connected to the synchronizer (3) by means of a support (44) in order to actuate said synchronizer, said support (44) comprising an actuating arm (46) which actuates a movable element (30) of the synchronizer (3) in order to engage said element on a driven gear (21) of said first pair of gears or on a driven gear (22) of said second pair of gears so as to select the desired gear ratio.

5. The transmission assembly (100) according to claim 1, further comprising a detecting device (7) which detects the axial position of the rod.

6. The transmission assembly (100) according to claim 5, wherein said detecting device (7) comprises a pair of sensor elements (71, 72) which detect the position of respective identification elements (47) associated with the rod.

7. The transmission assembly (100) according to claim 6, wherein said identification elements (47) are arranged on the opposite side of the enlarged portion (42) with respect to the support (44) and are arranged in an intermediate position between the support (44) and the opposite end (43).

8. The transmission assembly (100) according to claim 6, wherein the sensor elements (71, 72) comprise position switches which act on respective slots formed on the rod.

9. The transmission assembly (100) according to claim 8, wherein four slots are provided arranged such that, when the rod (40) is in a neutral position, the two position switches are in two end slots, whereas when the rod (40) is moved into one of the gears, one switch is in a corresponding central slot while the other is arranged in a position so as to not be engaged inside any of the slots.

10. The transmission assembly (100) according to claim 1, wherein said hydraulic circuit (6) comprises a pump (60) which delivers the operating fluid to one or more of said chambers, depending on the operating conditions, under the same working pressure.

11. The transmission assembly (100) according to claim 1, wherein the second pair of gears (12, 22) has a lower gear ratio than the first pair of gears (11, 21) and is positioned so as to be further away from the contact element (41) than the first pair of gears (11, 21).
